(19) United States
(12) Patent Application Publication
(10) Pub. No.: US 2006/0089836 A1
(43) Pub. Date: Apr. 27, 2006

(54) System and method of signal pre-conditioning with adaptive spectral tilt compensation for audio equalization

(75) Inventors: Marc A. Boillot, Plantation, FL (US); Brian L. Adair, Spring Hill, FL (US); Joseph M. Friedman, Plantation, FL (US); Karl F. Mueller, Sunrise, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/970,188

(22) Filed: Oct. 21, 2004

(51) Int. Cl. G10L 21/00

(52) U.S. Cl. 704/500

(57) ABSTRACT

Systems and methods for pre-conditioning a received audio signal prior to audio equalization of the audio signal are provided. The system (100) includes a spectral tilt estimator (110) for estimating a spectral tilt of the received audio signal, and a compensative filter synthesizer (115) for synthesizing a compensative filter based upon the spectral tilt estimated by the spectral tilt estimator. The filter comprises at least one compensative filter coefficient for mitigating the spectral tilt of the received audio signal prior to audio equalization of the audio signal.

### BACKGROUND

1. Field of the Invention

The present invention is related to the field of signal processing, and, more particularly, to the field of processing communication and voice-based signals.

2. Description of the Related Art

As is well understood, an audio signal can be communicated by modulating an electromagnetic (EM) carrier wave with the audio signal and conveying the wave via a channel to a receiver, which, in turn, recovers the audio signal. The received audio signal can serve as the input to the various communications and speech processing devices. A communication device can be, for example, a cell phone for receiving and processing audio signals via a wireless channel. A speech processing device can be, for example, a voice coding device comprising a speech analyzer, which converts analog speech waveforms into a narrowband digital signal, and a speech synthesizer, which converts the digital signals into artificial speech sounds.

In most such devices, spectral anomalies are often introduced into the audio signals as they are operated on by the devices. The introduction of spectral nulls and other anomalies into the signals can stem from the design of the device and/or the nature of the components used in the device. Thus, for example, the anomalies associated with an audio signal operated on by a cell phone or a voice coding device can arise as a result of the design or construction of the device's speaker, its housing, or one of its internal components. Accordingly, many such devices attempt to compensate for these spectral anomalies by subjecting the audio signal to audio equalization as the signal is being processed.

Equalization is a technique for separately controlling or adjusting the simultaneous vibrations at different frequencies that make up a signal such as an audio signal. An audio equalizer allows for the separate adjustment of the strength of the signal components within the different frequency ranges, or bands, that comprise the audio signal. Equalization of the audio signal thus provides a way for controlling the overall sound associated with the audio signal. Equalization of the audio signal is used, for example, to improve the clarity of the sound, to enhance its frequency response so as to thereby improve sound quality and/or loudness, or to otherwise affect the sound in some desirable manner. Some equalizers operate in real-time, while others apply equalization so as to alter a pre-recorded audio signal.

Equalization may be better accomplished if the audio signal to which the equalization is applied has a relatively flat or uniform spectrum over the relevant range of frequencies of the signal. In many instances, however, spectral anomalies are induced in the audio signal even before the signal is received. These spectral anomalies can be induced by the channel over which the underlying signal is conveyed to the receiver. One result is that the signal's power distribution, as a function of its frequencies, exhibits what is termed spectral tilt. Spectral tilt can be defined mathematically in terms of the slope of a straight-line curve fitted to the signal's power spectrum mapped against the underlying frequencies of the signal. Any signal conveyed through a communication or audio channel, therefore, may exhibit a certain level of spectral tilt when initially received by a receiver and prior to the signal being transformed or processed by a communication or speech processing device.

There are existing devices and techniques that compensate for the spectral nulls and anomalies that may be produced in a device as a result of the device's housing, its speakers, or internal components. Typically, these devices and techniques operate best if a signal that, as received by the receiver, exhibits a nominally flat spectrum. Currently, however, these devices and techniques lack the capability for effectively and efficiently handling received audio signals that are subject to spectral tilt even before they are subjected to audio equalization.

### SUMMARY OF THE INVENTION

The present invention provides systems and methods for pre-conditioning a received audio signal prior to processing of the signal by a signal processing device. Pre-conditioning can improve the subsequent equalization to which the audio signal may be subjected. It can also increase the decibel (dB) headroom of the audio signal as well as mitigate the compressive effects often associated with limited dynamic range digital signal processing (DSP).

The systems and methods of the present invention provide for the estimation of spectral tilt of an audio signal and, based thereon, the generation of a filter with filter coefficients that mitigate the spectral tilt prior to audio equalization. The filter can be a finite impulse response (FIR) filter that is adaptively generated. The system and methods can be employed to effect a flattening of the spectrum of an audio signal prior to the signal being subjected to audio equalization, voice coding, speech recognition, or other type of processing.

A system according to one embodiment of the present invention can include a spectral tilt estimator for estimating a spectral tilt of the received audio signal. The system also can include a compensative filter synthesizer for synthesizing a compensative filter based upon the spectral tilt estimated by the spectral tilt estimator. The filter can comprise at least one compensative filter coefficient for mitigating the spectral tilt of the received audio signal prior to audio equalization or some other type of processing of the signal.

A method aspect of an embodiment of the present invention comprises steps for pre-conditioning an audio signal. The method can include receiving an electromagnetic (em) signal comprising the audio signal and estimating a spectral tilt of the received audio signal. The method can also include generating a compensative filter based upon the spectral tilt estimated. The compensative filter can include at least one compensative filter coefficient for mitigating the spectral tilt of the received audio signal prior to audio equalization of the audio signal.

### BRIEF DESCRIPTION OF THE DRAWINGS

There are shown in the drawings various embodiments, it being understood, however, that the invention is not limited to the precise arrangements and instrumentalities shown.

FIG. 1 is a schematic diagram of a system for pre-conditioning a received audio signal prior to the signal being subjected to signal processing according to one embodiment of the present invention.

FIG. 2 is a schematic diagram of a system for pre-conditioning a received audio signal prior to the signal being subjected to signal processing according to another embodiment of the invention.

FIG. 3 is a flowchart illustrative of a method for pre-conditioning a received audio signal prior to the signal being subjected to signal processing according to still another embodiment of the invention.

### DETAILED DESCRIPTION OF THE INVENTION

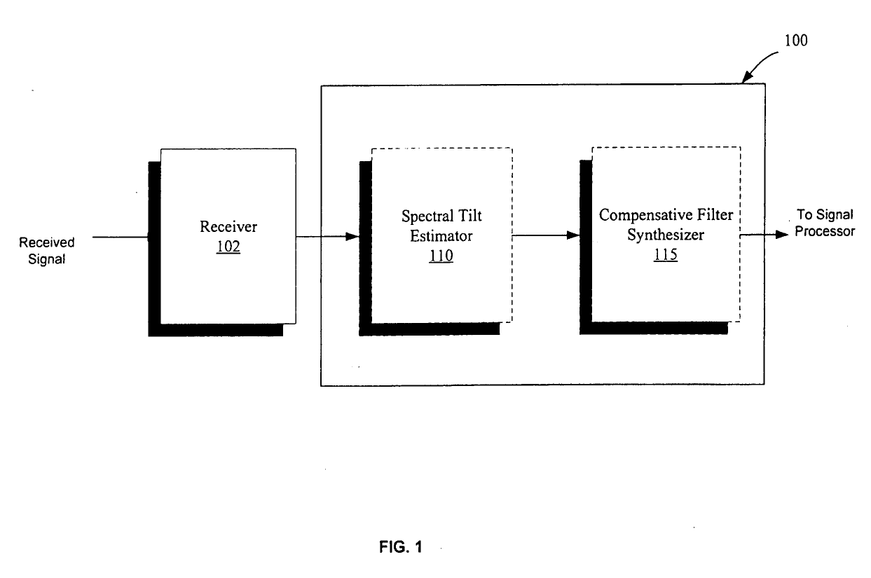

FIG. 1 provides a schematic diagram of a system 100 for pre-conditioning a received audio signal, according to one embodiment of the present invention. The system 100 can be used with different types of communications and speech processing devices. A communications device with which the system 100 can be used, for example, is a cell phone that relies on audio equalization to improve the quality of calls carried. A speech processing device with which the system can be used is a voice coding device that also relies on signal processing to improve the quality of the speech synthesized and/or recognized by the device. Indeed, from the ensuing discussion, it will be readily apparent to one of ordinary skill in the art that the system 100 can be advantageously employed with any device whose performance is enhanced through signal processing of an audio signal already having a relatively flat spectral density. Accordingly, the pre-conditioning of the received audio signal is performed by the system 100 prior to audio equalization or other processing being performed by the communication or speech processing device with which the system is used.

As illustrated in FIG. 1, the system 100 includes a spectral tilt estimator 110 that estimates the spectral tilt of the audio signal received by a receiver 102 connected to the system. The system 100 also illustratively includes a compensative filter synthesizer 115 connected with the spectral tilt estimator 110.

The spectral tilt estimator 110 provides an estimate of the spectral tilt of the received signal. According to one embodiment, the spectral tilt estimator 110 estimates the spectral tilt by first determining the power spectral density of the received signal. As will be readily understood by one of ordinary skill in the art, the power spectral density of a finite-power signal can be defined according to the following equation based on discrete samples of the audio signal:

$$P ( ω ) = {lim}_{N \to ∞} \frac{1}{N} E \{ {\vert {\sum }_{n = - ( N - 1 ) / 2}^{( N - 1 ) / 2} x [ n ] {ⅇ}^{- ⅇjω} \vert}^{2} \} ,$$

where E is the mathematical expectation operator. As will also be readily understood by one of ordinary skill in the art, an estimate of the power spectral alternately can be defined in terms of a periodogram using a discrete-time Fourier transform (DTF) of a windowed sequence of samples of the audio signal:

$$\overline{P} ( ω ) = \frac{1}{L} {\vert {\sum }_{n = 0}^{L - 1} x [ n ] {ⅇ}^{- jω n} \vert}^{2} .$$

Various techniques for determining the power spectral density of the audio signal can be implemented by the spectral tilt estimator 110. According to a particular embodiment, the spectral tilt estimator 110 estimates the power spectral density of the received signal using the Welch periodogram method. Accordingly, the audio signal can be initially segmented into a sequence of overlapping sections. Each section can then be de-trended by removing from each of the sequences its corresponding DC component. Subsequently, each section can be windowed by representing an idealized desired frequency response in terms of an impulse response sequence based on the sequence of overlapping sections. Each windowed section can then be zero padded by augmenting the sequences with zero amplitude sequences. Finally, the magnitudes of the DFTs produced as a result of the foregoing steps can be squared, and an average of these squared magnitudes is obtained.

Having determined the power spectral density of the audio signal, the spectral tilt estimator 110 according to this particular embodiment estimates the spectral tilt of the audio signal by fitting a curve to the resulting power spectral density using one of various curve fitting techniques. According to one embodiment, the curve fitting technique employed by the spectral tilt estimator 110 is to fit a polynomial function to the power distribution of the audio signal mapped to its frequencies. More particularly, according to this embodiment, the polynomial function is a first-order polynomial. The first-order polynomial, moreover, can be estimated by the spectral tilt estimator 110 based upon a minimum least squares regression of the power distribution of the audio signal against its frequencies. As will be readily understood by one of ordinary skill in the art, a minimum least squares regression for determining a first-order polynomial generates a minimum least square estimate (MLSE) coefficient. This coefficient can describe the slope of a straight line regressed on, or fitted to, the power spectrum of the audio signal.

Turning now to the compensative filter synthesizer 115 shown in FIG. 1, the compensative filter synthesizer can synthesize, or generate, a compensative filter based upon the spectral tilt estimated by the spectral tilt estimator 110. The filters synthesized by the compensative filter synthesizer 115 can include at least one compensative filter coefficient, the compensative filter coefficient being designed to mitigate the spectral tilt estimated by the spectral tilt estimator 110. The compensative coefficient filters enable the calculation of an offset that, if added to the audio signal, removes the effect of the spectral tilt of the signal. More particularly, the value based upon the compensative spectral coefficient filters can be an additive inverse of the estimated spectral tilt, which when combined with the received signal results in a flattening out of the spectrum of the received audio signal.

Accordingly, the pre-conditioning of the received audio signal by the system 100 mitigates the spectral tilt of the received audio signal prior to audio equalization or other processing of the audio signal. This not only can improve the subsequent audio equalization of the received signal, but also can increase the dB-measured headroom in the device in which, or with which, the system 100 is used. The pre-conditioning of the received audio signal by the system 100 also can efficiently mitigate the compressive effects that often result with limited-range dynamic digital signal processors (DSP).

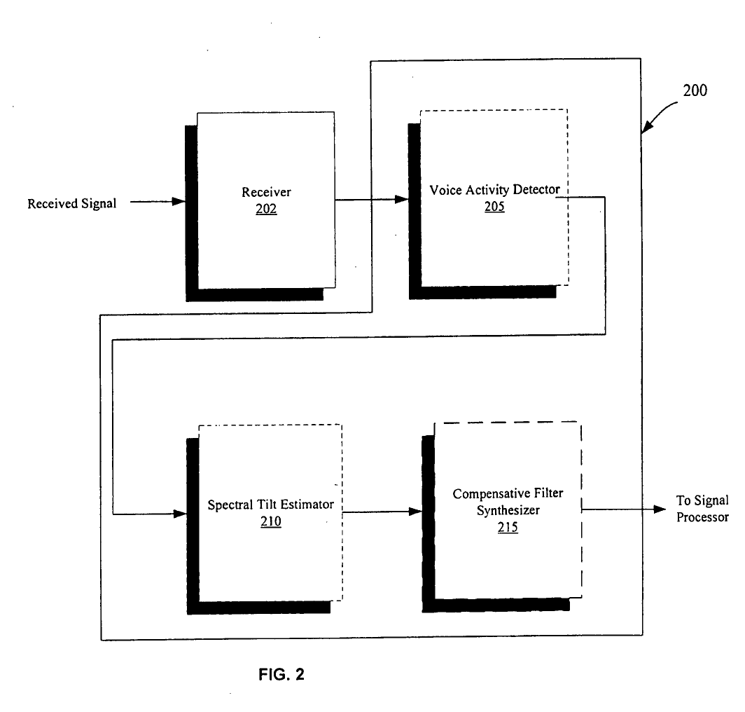

According to still another embodiment of the present invention as shown in FIG. 2, a system 200 for pre-conditioning a received audio signal prior to audio equalization or other processing of the audio signal further includes a voice activity detector (VAD) 205. The audio signal, when received by a receiver 202 connected to the system 200, passes the audio signal to the VAD 205. The VAD 205 identifies regions of voiced speech activity associated with the received audio signal. The regions of voiced speech activity derived from the received audio signal are the regions for which spectral tilt are calculated by the spectral tilt estimator 210 of the system 200. Once the spectral tilt of the audio signal has been estimated by the spectral tilt estimator 210, a compensative filter synthesizer 215 connected thereto synthesizes a compensative filter based upon the spectral tilt estimate. As already described in the context of other embodiments, the compensative filter comprises at least one compensative filter coefficient for mitigating the effect of spectral tilt of the received audio signal prior to audio equalization or other processing of the audio signal.

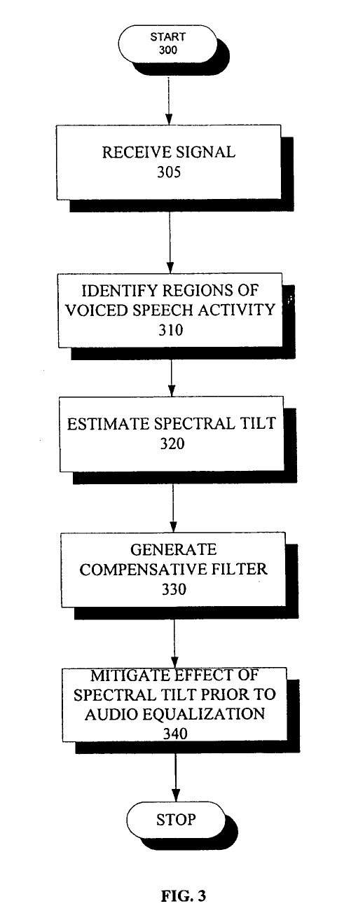

A method aspect of an embodiment the present invention is illustrated by the flowchart of FIG. 3. As shown, a method 300 includes at step 305 receiving an electromagnetic (em) signal comprising the audio signal. Regions of voiced speech activity in the received audio signal are identified at step 310. At step 320 the spectral tilt of the received audio signal is estimated. Using the estimated spectral tilt, a compensative filter is generated at step 330 based upon the spectral tilt estimated, wherein the compensative filter comprises at least one compensative filter coefficient for mitigating the effect of the spectral tilt of the received audio signal prior to audio equalization or other processing of the audio signal. At step 340, the method 300 includes mitigating the effect of the spectral tilt using the compensative filter generated in the preceding step.

More particularly, the estimation of the spectral tilt of the received audio signal at step 320, according to one embodiment, comprises determining a power spectral density of the received audio signal. The spectral power density can be determined according to the Welch periodogram method already described. Moreover, according to a particular embodiment, the spectral tilt can be determined by fitting an n-th order polynomial curve to the power distribution of the audio signal. The n-th order polynomial can be a first-order polynomial and can be based upon a minimum least squares regression. Other curve fitting techniques in addition to or in lieu of polynomial curve fitting can be used in estimating the spectral tilt. Similarly, other computational techniques in addition to or lieu of minimum least squares regression can be used.

Lastly, with regard to steps 330 and 340, the effect of the spectral tilt can be mitigated by computing an offset based upon the compensative coefficient filters generated. In particular, the offset based upon the compensative spectral coefficient filters can comprise an additive inverse of the estimated spectral tilt, which when combined with the received signal results in a flattening out of the spectrum of the received audio signal.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A system for pre-conditioning a received audio signal prior to audio equalization or other processing of the audio signal, the system comprising:
a spectral tilt estimator for estimating a spectral tilt of the received audio signal; and
a compensative filter synthesizer for synthesizing a compensative filter based upon the spectral tilt estimated by the spectral tilt estimator, the filter comprising at least one compensative filter coefficient for mitigating the spectral tilt of the received audio signal prior to audio equalization or other processing of the audio signal.

2. The system of claim 1, further comprising a voice activity detector for identifying regions of voiced speech activity associated with the received audio signal.

3. The system of claim 1, wherein the spectral tilt estimator estimates the spectral tilt by determining a power spectral density of the received audio signal.

4. The system of claim 3, wherein the spectral tilt estimator determines the power spectrum density of the audio signal based upon a Welch periodogram.

5. The system of claim 1, wherein the spectral tilt estimator estimates the spectral tilt based upon a polynomial function of a predetermined order.

6. The system of claim 5, wherein the predetermined order of the polynomial function is one.

7. The system of claim 5, wherein the polynomial function of a predetermined order comprises at least one minimum least squares estimate (MLSE) coefficient.

8. The system of claim 1, wherein the compensative filter synthesizer generates an additive inverse based for offsetting the spectral tilt of the received audio signal.

9. A method of pre-conditioning an audio signal prior to audio equalization or other processing of the audio signal, the method comprising the steps of:
receiving an electromagnetic signal comprising the audio signal;
estimating a spectral tilt of the audio signal; and
generating a compensative filter based upon the spectral tilt estimated, the compensative filter comprising at least one compensative filter coefficient for mitigating the spectral tilt of the received audio signal prior to audio equalization of the audio signal.

10. The method of claim 9, further comprising identifying regions of voiced speech activity corresponding to the audio signal.

11. The method of claim 9, wherein estimating comprises determining a power spectral density of the audio signal.

12. The method of claim 11, wherein determining the power spectral density of the audio signal comprises the steps of:
segmenting the audio signal into a sequence of overlapping sections;
de-trending each section to remove a corresponding to DC component;
windowing and zero-padding each section;
generating a discrete-time Fourier transform corresponding to each section; and
computing an average of squared values based upon the discrete-time Fourier transforms.

13. The method of claim 9, wherein estimating comprises generating a polynomial equation having a predetermined order.

14. The method of claim 13, wherein the polynomial equation is generated based upon a power spectral density of the audio signal.

15. The method of claim 13, wherein the polynomial equation having a predetermined order is a first-order polynomial equation.

16. The method of claim 11, wherein the polynomial equation comprises at least one minimum least squares estimate (MLSE) coefficient.

17. The method of claim 9 wherein generating comprises generating an additive inverse for offsetting the spectral tilt.

18. A computer-readable storage medium for use in pre-conditioning an audio signal prior to audio equalization or other processing of the audio signal, the storage medium comprising computer instructions for:
estimating a spectral tilt of the audio signal; and
generating a compensative filter based upon the spectral tilt estimated, the compensative filter comprising at least one compensative filter coefficient for mitigating the spectral tilt of the received audio signal prior to audio equalization of the audio signal.

19. The computer-readable storage medium of claim 18, further comprising a computer instruction for identifying regions of voiced speech activity corresponding to the audio signal.

20. The computer-readable storage medium of claim 18, wherein the instruction for generating comprises an instruction for generating an additive inverse for offsetting the spectral tilt.
